(19) United States
(12) Patent Application Publication
(10) Pub. No.: US 2001/0008210 A1
(43) Pub. Date: Jul. 19, 2001

(54) METHOD AN APPARATUS FOR MEASURING THE PH OF PURE WATER

(76) Inventors: FARID AHMAD, COLLEGEVILLE, PA (US); JOHN D. FOGEL, SCHWENKSVILLE, PA (US); HAROLD M. TERWILLIGER, HOLLAND, PA (US)

Correspondence Address: HONEYWELL INTERNATIONAL INC., 101 COLUMBIA ROAD, P O BOX 2245, MORRISTOWN, NJ, 07962-2245, US

(21) Appl. No.: 09/195,372

(22) Filed: Nov. 18, 1998

(51) Int. Cl. G01N 27/413

(52) U.S. Cl. 204/402; 204/406; 204/409; 204/435; 204/420; 204/433

(57) ABSTRACT

The apparatus of the invention includes a flow chamber having an inlet, an outlet, and a removable cover. The cover includes fittings for mounting a reference electrode assembly, a measuring electrode assembly, and a combined counter electrode/thermistor probe. According to the one illustrative embodiment invention, the flow chamber is substantially cylindrical with the inlet located near the bottom of the chamber and the outlet located near the top of the chamber. The axes of the inlet and outlet lie in the same plane as and are parallel to a diameter of the chamber. The inner diameter of the inlet is reduced to approximately ⅛″ so that the velocity of water entering the chamber is increased. The inner diameter of the outlet is approximately ¼″ so that the velocity of water exiting the chamber is less than the velocity of water entering the chamber. The reference electrode is located with its porous frit directly above the inlet and the measuring electrode is located adjacent to the outlet. The inlet flow is dynamically balanced for optimum performance of the reference electrode. The molarity of KCl in the reference electrode and the flow rate of the reference frit are balanced with the inlet turbulence. The balance of these parameters significantly reduces or eliminates noise related to the effects of parasitic junction potentials thereby significantly increasing the accuracy of the measurements.

### BACKGROUND OF THE INVENTION

1. Field of the Invention

The invention relates to a method and apparatus for potentiometric electrochemical pH measurement. More particularly, the invention relates to a method and apparatus for measurement of pH in pure water utilizing ion selective probe systems disposed in a flow chamber bowl.

2. State of the Art

A prior art apparatus for potentiometric electrochemical pH measurement is illustrated in FIG. 1.

The apparatus shown in FIG. 1 includes an operational amplifier 10, a reference electrode 12, a glass pH electrode 16, a counter electrode 30, a buffer amplifier 32, a microprocessor based measuring system 26 and a display device 28.

The reference electrode 12 is coupled to the high impedance input of the buffer amplifier 32 which drives the measuring system 26. The glass pH electrode 16 is coupled by line 18 to the inverting input of the amplifier 10; and the low impedance output of the amplifier 10 is coupled by line 14 to a metal wire “counter electrode” 30. The three electrodes are placed in a grounded container 24 containing the solution 22 under test.

The pH glass electrode 16 is held at circuit common by the counter electrode 30 and the potential sensed by the reference electrode is proportional to the pH of the solution 22.

Difficulties are often met in measuring the pH of samples with a low conductivity. This is particularly true for high-purity water (conductivity less than 1 Micro Scm produced by distillation, deionization or reverse osmosis. It sometimes appears impossible to determine the pH of such samples.

An apparatus suitable for measuring the pH of pure water is shown in FIG. 2.

The apparatus 40 depicted in FIG. 2 includes a reference electrode 42, a measuring electrode 43, and a counter electrode 44 mounted in a flow chamber 46. The electrode and flow chamber assembly is mounted on a panel 48 which also supports a reservoir 50 for an electrolyte, e.g. salt solution such as KC1.

The reference electrode 42 is typically a silver/silver chloride electrode in a glass tube with a porous frit at the end of the tube. The electrolyte flows from the reservoir into the reference electrode and through the frit into the water sample.

According to a state of the art system, the counter electrode is mounted together with a temperature probe so that measurements can be corrected for changes in the temperature of the water.

The flow chamber 46 is a stainless steel bowl having a ¾″ NPT bottom inlet 52 and a ¾″ NPT side outlet. The location and dimensions of the inlet and outlet are chosen so that turbulence is minimized.

It is generally assumed that stirring of the solution has an adverse effect on pH measurement. When a solution is stirred as its pH is being measured or if the measurement cell is otherwise subjected to a flow, then there is frequently an perturbation of the measured pH. This is referred to as the stirring error.

Under unfavorable conditions the stirring error can amount to as much as 40 mV. It is assumed that most of the errors from the stirring effect occur at the reference electrode where the turbulent flow of water displaces the electrolyte diffusion zone.

Sophisticated state of the art pH sensors can achieve an accuracy of approximately 0.2 pH in pure water having a resistance of 18.2 Megohm. However, even greater accuracy is desirable.

### SUMMARY OF THE INVENTION

It is therefore an object of the invention to provide a method and apparatus for potentiometric electrochemical pH measurement.

It is also an object of the invention to provide a method and apparatus for measurement of pH in pure water utilizing ion selective probe systems disposed in a flow chamber bowl.

It is another object of the invention to provide a method and apparatus for measurement of pH in pure water utilizing ion selective probe systems disposed in a flow chamber bowl which is more accurate than present systems.

In accord with these objects which will be discussed in detail below, the apparatus of the present invention includes a flow chamber having an inlet, an outlet, and a removable cover.

The cover includes fittings for mounting a reference electrode assembly, a measuring electrode assembly, and a combined counter electrode/thermistor probe.

The reference electrode includes a fitting for coupling it to a source of electrolyte.

According to an illustrative embodiment of the invention (where specific dimensions are set forth for the sake of illustration only), the flow chamber is substantially cylindrical with the inlet located near the bottom of the chamber and the outlet located near the top of the chamber. The axes of the inlet and outlet lie in the same plane as and are perpendicular to a diameter of the chamber.

Furthermore, according to the illustrative embodiment of the invention, the inner diameter of the inlet is reduced to approximately ⅛″ so that the velocity of water entering the chamber is increased. The inner diameter of the outlet is approximately ¼″ so that the velocity of water exiting the chamber is less than the velocity of water entering the chamber.

The reference electrode is located with its porous frit directly above the inlet and the measuring electrode is located adjacent to the outlet. The inlet flow is dynamically balanced for optimum performance of the reference electrode.

The molarity of KC1 in the reference electrode and the flow rate of the reference frit are balanced with the inlet turbulence. The balance of these parameters significantly reduces or eliminates noise related to the effects of parasitic junction potentials thereby significantly increasing the accuracy of the measurements.

According to the method of the invention, therefore, contrary to the teachings of the prior art, a hydrodynamic fluid envelope is created between the reference electrode and the measuring electrode. This path is such that electrolyte is drawn from the frit of the reference electrode and carried to the measuring electrode and out of the chamber through the outlet.

According to a presently preferred embodiment of the invention, the molarity of the KCl is 1.0 Molar. The presently preferred flow rate of water through the chamber is 13 ml per day and the presently preferred flow rate for electrolyte is from 50 cc/min to 500 cc/min and the presently preferred flow rate for electrolyte is from 0.1 ml/hr to 0.5 ml/hr.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic diagram of a prior art system for potentiometric electrochemical pH measurement;

FIG. 2 is a side elevational view of a suitable system for measurement of pH in pure water utilizing ion an selective probe system disposed in a flow chamber bowl;

FIG. 3 is an exploded view of a system for measurement of pH in pure water according to the invention;

FIG. 4 is a schematic sectional view of the system according to the invention;

FIG. 5 is a schematic illustration of the hydrodynamic fluid envelope between the reference electrode and the measuring electrode; and

FIGS. 6 and 7 are side elevational views of measurement system according to the invention mounted on a panel with an electrolyte reservoir.

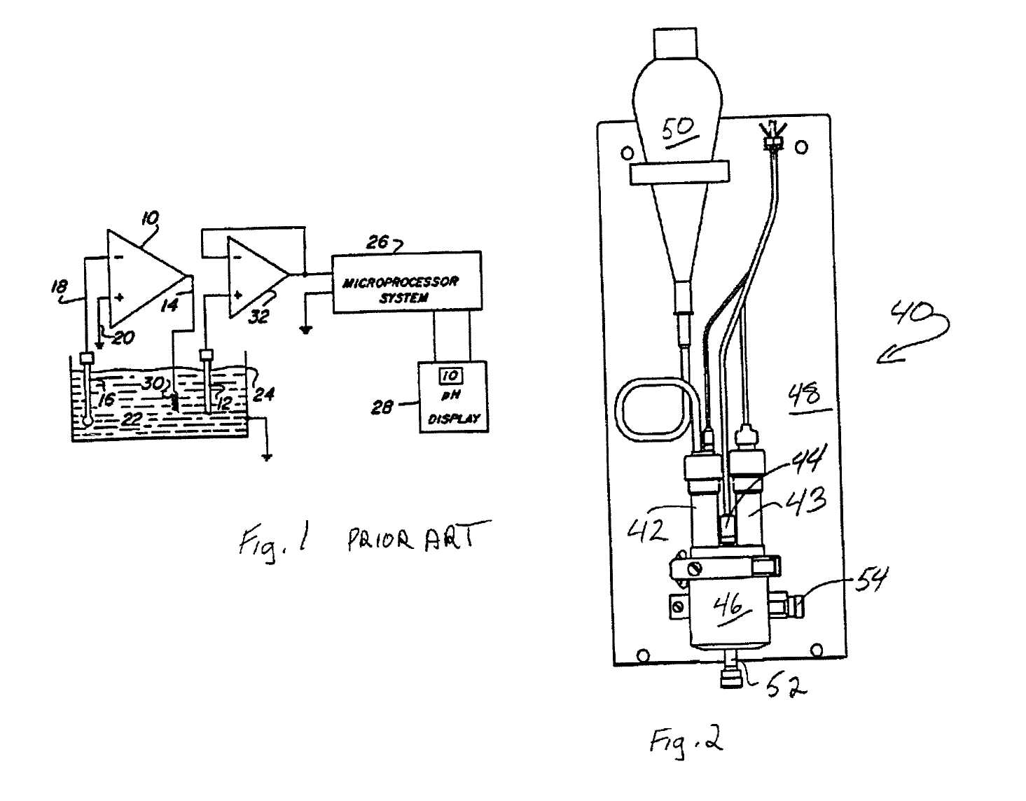

### DETAILED DESCRIPTION OF THE PREFERRED EMBODIMENTS

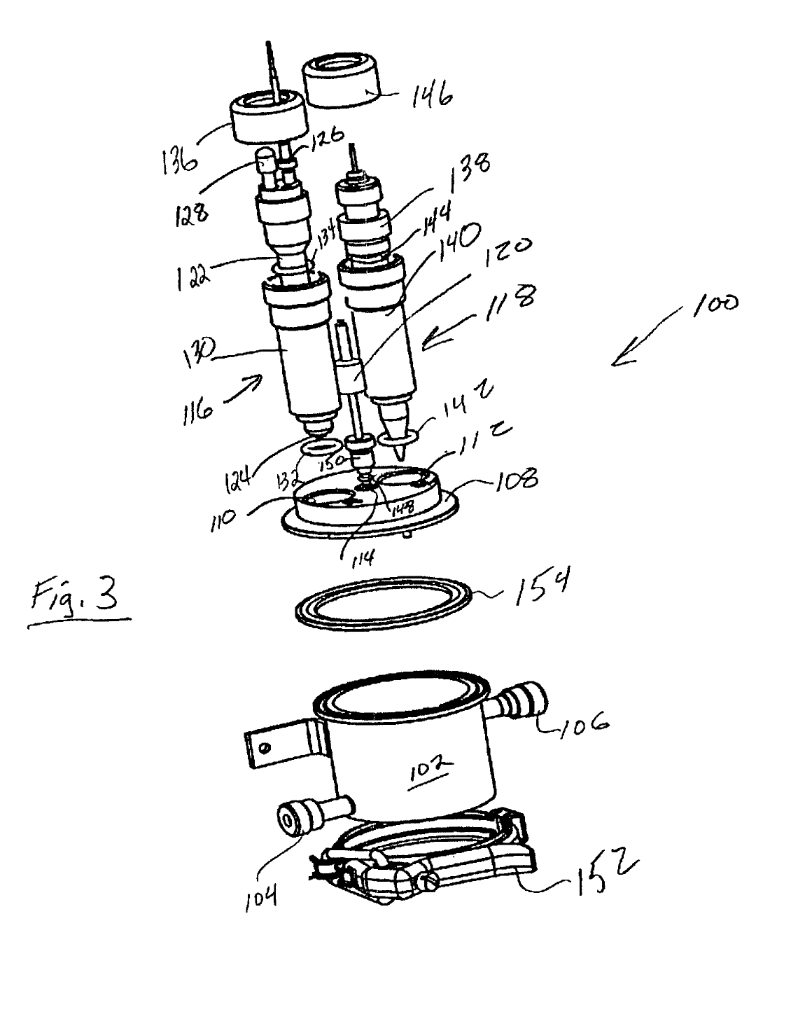

Referring now to FIG. 3, the apparatus 100 of the present invention includes a stainless steel flow chamber 102 having an inlet 104, an outlet 106, and a removable cover 108. The cover includes threaded fittings 110, 112, 114 for mounting a reference electrode assembly 116, a measuring electrode assembly 118, and a combined counter electrode/thermistor probe 120.

The reference electrode 116 includes a glass tube 122 with a porous frit 124 at one end, a shielded cable connection 126, and a fitting 128 for coupling to a supply of electrolyte. The tube 122 is mounted in a stainless steel cylinder 130 with the aid of O-rings 132, 134 and a screw cap 136. The cylinder 130 threadably joins the fitting 110.

Similarly, the measuring electrode assembly 118 includes an electrode 138 which is mounted in a stainless steel cylinder 140 with the aid of O-rings 142, 144 and a screw cap 146. The cylinder 140 threadably joins the fitting 112. The counter electrode/thermistor probe 120 is mounted with the aid of an O-ring 148 and a compression nut 150.

The flow chamber 102 is substantially cylindrical with the inlet 104 located near the bottom of the chamber and the outlet 106 located near the top of the chamber. The axes of the inlet and outlet lie in the same plane as and are perpendicular to a diameter of the chamber. The cover 108 is removably coupled to the chamber 102 with a triclover clamp 152 and a gasket 154.

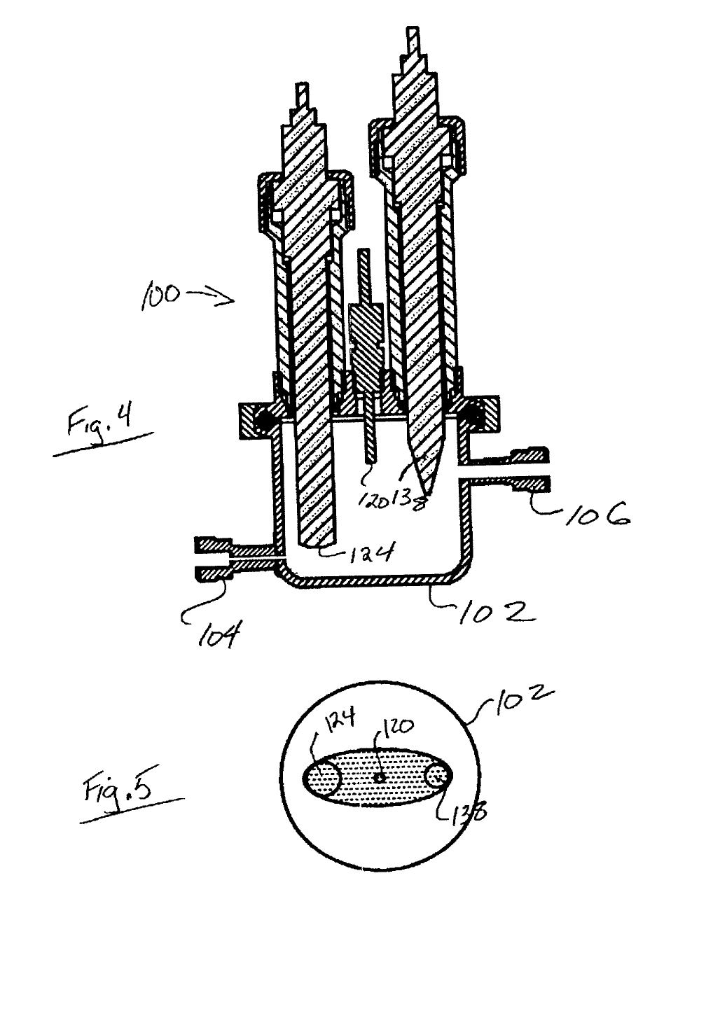

Turning now to FIGS. 4 and 5, the flow chamber 102 is preferably, according to the illustrative embodiment of the invention being set forth herein for the purpose of demonstrating the principals of the invention only, 2.5+/−0.2 inches tall and 2.70+/−0.2 inches in diameter.

The inner diameter of the inlet 104 is reduced to approximately ⅛″ so that the velocity of water entering the chamber is increased. The inner diameter of the outlet 106 is approximately ¼″ so that the velocity of water exiting the chamber is less than the velocity of water entering the chamber. The inlet 104 is located 0.41+/−0.10 inches from the bottom of the chamber 102 and the outlet 106 is located 1.75+/−0.20 inches from the bottom of the chamber.

The reference electrode is located with its porous frit 124 directly above the inlet 104 and the measuring electrode 138 is located adjacent to the outlet 106.

According to the invention, the inlet flow is dynamically balanced for the optimum performance of the reference electrode. Also, the molarity of KC1 in the reference electrode and the flow rate of the reference frit are balanced with the inlet turbulence. The balance of these parameters significantly reduces or eliminates noise related to the effects of parasitic junction potentials thereby significantly increasing the accuracy of the measurements.

More particularly, according to the invention, the inlet flow rate and turbulence developed should be sufficient to (a) continuously wash out frit 124 keeping the KCL/water boundary in the frit at a predetermined location to minimize the production of parasitic junction potentials (said predetermined location being empirically derived based on chamber volume, size of chamber openings and components, etc.); and (b) carry the KCL/water solution to the measuring electrode with a predetermined velocity and in sufficient volume (said time period and volume also being empirically derived), to bathe the broad surface of the measuring electrode to enhance the measuring signal produced thereby.

According to the method of the invention, a hydrodynamic fluid envelope is created between the reference electrode frit 124 and the measuring electrode 138. This path, which is shown schematically in FIG. 5, is such that electrolyte is drawn from the frit 124 of the reference electrode and carried to the measuring electrode 138 and out of the chamber 102 through the outlet 106.

According to a presently preferred embodiment of the invention, the molarity of the KC1 is 1.0 Molar. The presently preferred flow rate of water through the chamber is from 50 cc/min to 500 cc/min and the presently preferred flow rate for electrolyte is from 0.1 ml/hr to 0.5 ml/hr.

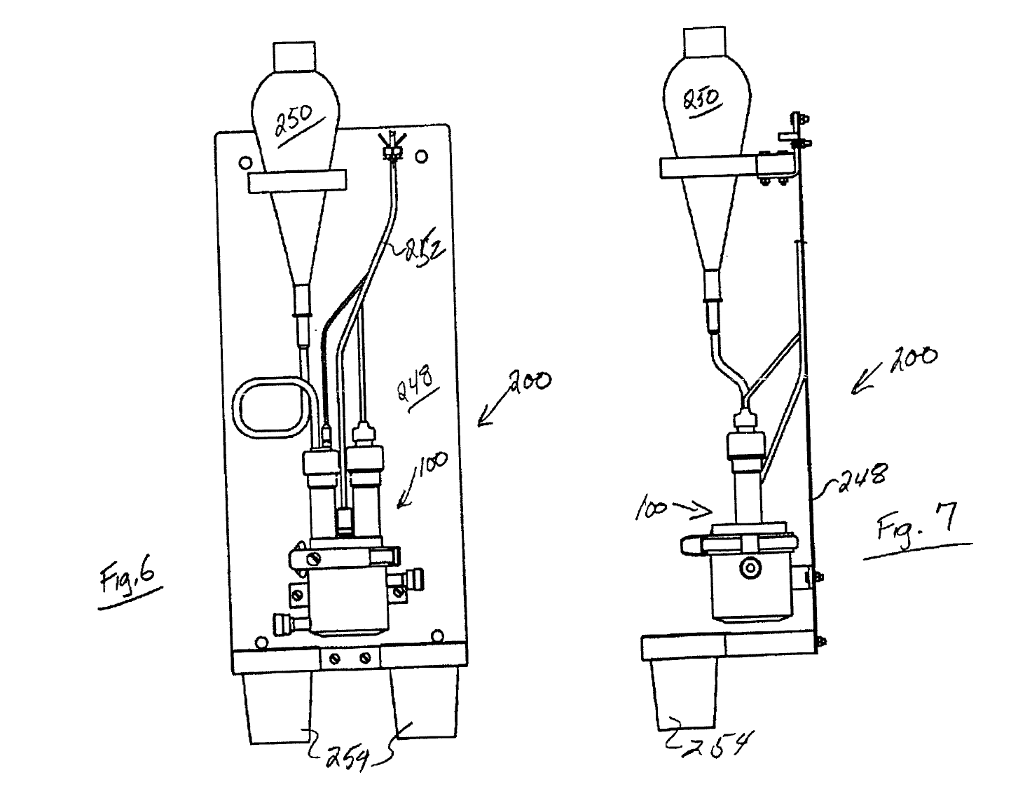

Turning now to FIGS. 6 and 7, a panel assembly 200 according to the invention includes the apparatus 100 mounted on a panel 248 which holds an electrolyte reservoir 250 and a wiring harness 252. The panel 248 is also preferably provided with a pair of cup holders 254 to hold beakers filled with calibration fluid, i.e. fluid with a known pH. As mentioned above, the molarity of the KC1 solution in the reservoir 250 is preferably one.

There have been described and illustrated herein an apparatus for measuring the pH of pure water and a method for measuring the pH of pure water. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as so claimed.

What is claimed is:

1. An apparatus for measuring the pH of pure water, comprising:
(a) a reference electrode including means for dispensing an electrolyte;
(b) a measuring electrode;
(c) a flow chamber, said electrodes being disposed in said flow chamber with the pure water; and
(d) means for creating a hydrodynamic fluid envelope around said reference electrode and said measuring electrode.

2. An apparatus according to claim 1 wherein said hydrodynamic fluid envelope continuously washes out said means for dispensing an electrolyte keeping the electrolyte/water boundary at a predetermined location to minimize the production of parasitic junction potentials.

3. An apparatus according to claim 1 wherein said hydrodynamic fluid envelope carries the electrolyte/water solution to the measuring electrode with a predetermined velocity and in sufficient volume to bathe the broad surface of the measuring electrode to enhance the measuring signal produced thereby.

4. An apparatus according to claim 1 wherein said flow chamber has an inlet and an outlet, and said means for creating a hydrodynamic fluid envelope includes said inlet having a smaller diameter than said outlet.

5. An apparatus according to claim 1 wherein said flow chamber has an inlet and an outlet, and said means for creating a hydrodynamic fluid envelope includes said inlet and said outlet having axes which are substantially perpendicular lie substantially in the same plane.

6. An apparatus according to claim 1 wherein said means for creating a hydrodynamic fluid envelope includes means for maintaining a flow rate and turbulence within said chamber.

7. An apparatus according to claim 5 wherein said means for dispensing an electrolyte further comprises a glass frit and said frit is located adjacent to said inlet.

8. An apparatus according to claim 7 wherein said measuring electrode is located adjacent to said outlet.

9. An apparatus according to claim 8 wherein said chamber is substantially cylindrical, said inlet is adjacent the bottom of said chamber, and said outlet is adjacent the top of said chamber.

10. An apparatus according to claim 1 further comprising a counter electrode disposed in said chamber.

11. An apparatus according to claim 1 further comprising:
(a) a microprocessor system coupled to said electrodes; and
(b) a digital display coupled to said microprocessor system.

12. A method for measuring pH in pure water, comprising the steps of:
(a) disposing a reference electrode, including means for dispensing an electrolyte, and a measuring electrode in a flow chamber; and
(b) creating a hydrodynamic fluid envelope around said reference electrode and said measuring electrode.

13. A method according to claim 12 wherein said step of creating a hydrodynamic fluid envelope further comprises the step of arranging a flow of water around the electrodes which continuously washes out the means for dispensing an electrolyte keeping the electrolyte/water boundary at a predetermined location to minimize the production of parasitic junction potentials.

14. A method according to claim 12 wherein said step of creating a hydrodynamic fluid envelope further comprises the step of arranging a flow of water around the electrodes which carries the electrolyte/water solution to the measuring electrode with a predetermined velocity and in sufficient volume to bathe the broad surface of the measuring electrode to enhance the measuring signal produced thereby.

15. A method according to claim 12 further comprising the steps of:
(a) dispensing an electrolyte at a measured rate through the reference electrode; and
(b) arranging the flow of water so that electrolyte is drawn from the measuring electrode and carried to the measuring electrode.

16. A method according to claim 12 further comprising the step of arranging the flow of water so that electrolyte is carried from the measuring electrode out of the chamber.
